(19) United States
(12) Patent Application Publication
(10) Pub. No.: US 2025/0135954 A1
(43) Pub. Date: May 1, 2025

(54) DRIVER BEHAVIOR BASED VEHICLE CONTROL

(71) Applicant: FORD GLOBAL TECHNOLOGIES, LLC, DEARBORN, MI (US)

(72) Inventors: Ankit Saini, Novi, MI (US); Zhengyu Dai, Canton, MI (US); Guopeng Hu, Northville, MI (US); Yanan Zhao, Ann Arbor, MI (US)

(21) Appl. No.: 18/495,254

(22) Filed: Oct. 26, 2023

(51) Int. Cl. B60L 58/26; B60W 30/14; B60W 30/16; B60W 40/02

(52) U.S. Cl. CPC B60L 58/26; B60W 30/143; B60W 30/16; B60W 40/02; B60L 2240/12; B60L 2240/66; B60L 2260/56; B60W 2554/802; B60W 2555/20; B60W 2556/10

(57) ABSTRACT

A vehicle, among other things, may use predicted rates of change in vehicle speed based on past driving data of a particular user to allocate resources within the vehicle, to recreate the behavior of particular user in an automated driving system, or to accurately predict a capability of the vehicle.

### TECHNICAL FIELD

This disclosure relates to automotive technology.

### BACKGROUND

A vehicle may use energy for propulsion.

### SUMMARY

A vehicle may include a battery thermal management system and a controller. The controller may use data to change a rate of cooling of the battery thermal management system. The data may include a particular user operating the vehicle and a predicted rate of change in speed of the vehicle from a current speed to a target speed. The predicted rate of change in speed may be derived from data indicative of the particular user driving the vehicle while the speed changed from the current speed to the target speed. The controller may change the rate of cooling such that a greater the rate of change, a greater the change.

A method may generate a personalized adaptive cruise control behavior by acquiring data about a user and a predicted rate of change in speed then applying the user information and the predicted rate of change in speed to an adaptive cruise control system. The data about a user may include historic drive data generated by one or more vehicles driven by the user. The predicted rate of change in vehicle speed may be generated by a machine learning model that uses historic drive data as input. Applying the data and the predicted rate of change in speed to the adaptive cruise control system may modulate a control operation of the adaptive cruise control system.

A method may affect the accuracy of a distance-to-empty prediction by calculating a distance-to-empty, acquiring data about a user and a predicted rate of change in speed, then modulating the distance-to-empty according to the data and the predicted rate such that the greater the predicted rate, the greater modulation. The data about a user may include historic drive data generated by one or more vehicles driven by the user. The predicted rate of change in speed may be generated by a machine learning model that uses historic drive data as input.

### BRIEF DESCRIPTION OF THE DRAWINGS

FIG. 1 shows a vehicle including a controller that modulates a battery thermal management system according to the particular user driving the vehicle.

FIG. 2 shows a method employed by a controller for generating a personalized adaptive cruise control behavior.

FIG. 3 shows a method employed by a controller to affect the accuracy of a distance-to-empty prediction.

FIG. 4 shows an example speed vs. time graph generated for a user based on a route information.

FIG. 5 shows a flowchart to an example method to update predicted rates of change in speed for a particular user.

FIG. 6 shows an example speed vs. time graph of data taken during a particular user's drive.

FIG. 7 shows an example table for storing a particular user's predicted rates of change in speed.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A same vehicle over an otherwise equivalent use may use different amounts of energy depending on a behavior specific to a particular user. One aspect of the behavior is a rate of change in speed of the vehicle while the particular user operates the vehicle. Thus, a vehicle that uses predicted rates of change in speed, based on a past driving data of the particular user and generated via a machine learning model that takes as input the past driving data, may efficiently allocate resources to sub-systems (e.g., a battery cooling system) of the vehicle, may accurately predict a capability of the vehicle (e.g., a distance-to-empty), or may recreate the behavior of a particular user during an operation of an automated driving system (e.g., an adaptive cruise control). The machine learning model may be trained on a collection of actual change in speed data for a variety of drivers and for a variety of initial and final speeds.

A vehicle may collect various data about the vehicle itself, an environment, or a driver's behavior. For example, a vehicle may regularly collect data about a fuel level of the vehicle to output an expected range until the vehicle runs empty or to output an average fuel economy. Some vehicles output information about an ambient temperature or produce an alert about potential road icing. Some examples may involve sensors and displays as well as data storage and manipulation. Some examples also may include applying data collected to optimize a system of the vehicle.

In many vehicles, some systems may be influenced by a particular user's driving style. For example, consider Driver A who accelerates and decelerates at a greater rate of change in speed than other recorded drivers. Further consider Driver C who is a conservative driver that accelerates and decelerates at a lower rate of change in speed than an average of all drivers. In some vehicles, for example, Driver A may cause a motor to generate more heat than Driver C.

In battery-powered electric vehicles, many systems may be influenced similarly by a particular user's driving style. For example, consider Driver A and Driver C as above. Driver A may consume more energy, reduce a vehicle's distance-to-empty by a greater amount, and cause a battery to generate more heat than Driver C over an otherwise equivalent use.

The systems disclosed herein may collect, analyze, and apply data to accurately predict the distance-to-empty of a vehicle, to cool a power system of a vehicle, or to modulate an adaptive cruise control system of the vehicle. For example, consider Driver A and Driver C as above. A vehicle that stored and updated driving data specific to Driver A and to Driver C could apply each driver's data so that a battery thermal management system may be configured to remove more heat from the battery when Driver A is driving and may be configured to remove less heat from the battery when Driver C is driving over an otherwise equivalent use. In other words, the vehicle could anticipate a need of a battery thermal management system based on past behavior of a user and could allocate resources according to the anticipated need.

The vehicle here may collect data about the speed of the vehicle. In instances where a vehicle accelerates such that a speed monotonically increases over an interval created by an initial speed and a final speed, a vehicle may further collect an average acceleration by dividing the interval by the time the vehicle took to span the interval. For example, if the vehicle is initially moving at 10 mph and accelerates to 25 mph over 2 seconds, the interval would be (25 mph-10 mph)=15 mph, the time the vehicle took to span the interval would be 2 s, and thus the average acceleration would be 15 mph/2 s=7.5 mph/s. Embodiments could use any units.

In instances where a speed of a vehicle does not monotonically increase, the data collected may be discarded. A vehicle may use filters other than monotonicity, such as by discarding present rates of change in speed when they are not sufficiently different from the predicted rates of change in speed.

Similarly, in instances where a vehicle decelerates such that a speed monotonically decreases over an interval created by an initial speed and a final speed, a vehicle may further collect an average deceleration by dividing the interval by the time the vehicle took to span the interval. For example, if the vehicle is initially moving at 55 mph and decelerates to 0 mph over 5.5 seconds, the interval would be (0 mph-55 mph)=−55 mph, the time the vehicle took to span the interval would be 5.5 seconds, and thus the average deceleration would be −55 mph/5.5 seconds=−10 mph/s.

In instances where a speed of a vehicle does not monotonically decrease, the data collected may be discarded. A vehicle may use filters other than monotonicity, such as by discarding present rates of change in speed when they are not sufficiently different from the predicted rates of change in speed.

Equivalently to storing acceleration or deceleration data, a vehicle could collect times describing how long the vehicle takes to accelerate or decelerate monotonically from an initial speed to a final speed while a particular user uses the vehicle. A vehicle could predefine intervals of speeds between an initial speed and a final speed to store this time data. In instances where the vehicle accelerates over an actual interval greater than the predefined interval, the vehicle may collect times for each predefined interval within the actual interval. For example, if a speed of the vehicle monotonically increases from 6 mph to 36 mph (36 mph-6 mph=a 30-mph actual interval) and the predefined intervals are 3 mph (e.g., 0-3 mph, 3-6 mph, . . . , 30-33 mph, 33-36 mph) the vehicle may record and store the times the vehicle took to accelerate over each of the ten predefined intervals.

The vehicle here may store predictions—average acceleration and average deceleration values—and continually update those predictions as the vehicle is used by a particular user. For example, consider Driver A and Driver C as above. A vehicle may have stored a prediction that Driver A will accelerate from 5 mph to 10 mph over 0.30 seconds and a second prediction that Driver C will accelerate from 5 mph to 10 mph over 1 second. If, during a use of the vehicle by Driver A, the vehicle accelerates from 5 mph to 10 mph over 0.5 seconds, the vehicle may update the prediction specific to Driver A without changing the second prediction specific to Driver C. The predictions after updating may be, for example, that Driver A will accelerate from 5 mph to 10 mph over 0.33 seconds and that Driver C will accelerate from 5 mph to 10 mph over 1 second.

To update a predicted rate, a user may generate a present rate of change in speed by changing from an initial speed to a final speed. The vehicle may record this present rate.

To update a predicted rate, the vehicle may compare the present rate of change in speed to a threshold value. In embodiments using this method, if the actual rate is less than a threshold value, the vehicle may preclude updating, but if the actual rate is greater than the threshold value, the vehicle may use the actual rate to update the predicted rate.

Before updating, the vehicle may discard the present rate of change in speed unless the vehicle accelerated or decelerated monotonically over a speed interval.

The vehicle here may use machine learning algorithms to capture, test, generate, and/or update predictions. For example, a machine learning algorithm could be used to collect a subset of actual rates of change in speed from a larger dataset collected over a drive. In another example, a machine learning algorithm could be used to validate a set of initialized or updated values. In another embodiment, a machine learning algorithm could be used to update the stored values.

In an example embodiment of using a machine learning algorithm to update a predicted rate using a present rate, the present rate could be randomly assigned to a train or test dataset. Then, when a condition is reached such as when the train and test sets have grown 10% from the last time the predicted rate was updated, a machine learning algorithm could be retrained to generate a new collection of predicted rates for all speed intervals.

The vehicle here may incorporate other information when changing a system such as the battery thermal management system. For example, assume the predicted rate would cause the controller to increase cooling by 2% without incorporating additional information. If the controller uses additional information, such as the presence of a congested route or work zone ahead, the controller may only increase cooling by 1.2%.

The vehicle here may store predicted values to be recalled later. One embodiment may include storing predicted values in a table. In this embodiment, one axis of the table may include an initial speed, another axis of the table may include a final speed, and a cell at the intersection of the initial speed and final speed may include one predicted value. The predicted value may correspond to a time or to a rate of change of a speed of the vehicle.

The vehicle here may store multiple predicted values corresponding to multiple users. One embodiment that uses a table as constructed above to store predicted values may have one table per user. In this embodiment, predicted values for a particular user currently using the vehicle can be recalled from storage, updated, or applied without affecting the predicted values of other users.

The vehicle here may apply at least one predicted value to optimize a system of the vehicle. For example, consider Driver A and Driver C as above. The vehicle may estimate from the predicted values specific to Driver A and from the second predicted values specific to Driver C that the vehicle may generate more heat when Driver A is using the vehicle than when Driver C is using the vehicle. Accordingly, the vehicle may increase activity of a cooling system when Driver A is using the vehicle and decrease activity of a cooling system when Driver C is using the vehicle.

The vehicle may combine additional information with at least one predicted value to optimize a system of the vehicle. For example, if a user inputs a route into a navigation system of the vehicle, the vehicle may use speed limit data along the route to generate an expected speed over an estimated duration of the route. Then, the vehicle may apply predicted acceleration values for the particular user to any changes in the expected speed to adjust the duration, resulting in a drive profile personalized to the particular user. This drive profile could then be used to prepare resources before a change in expected speed, such as by allocating more power to a cooling system to begin cooling the battery before a change in expected speed.

The vehicle here may use at least one predicted value to display personalized information to a user. For example, consider Driver A and Driver C as above. One embodiment may include two otherwise equivalent vehicles displaying a lower distance-to-empty to Driver A than to Driver C because of the larger predicted rates of change of Driver A compared to Driver C.

The vehicle may thus use information about a user's past rates of change in speed from an initial speed to a final speed to generate a predicted rate for the initial speed to the final speed. The predicted rate may be applied to a system of the vehicle to modulate its output. For example, the vehicle may use information that Driver A accelerated from 10 mph to 20 mph over 0.5 seconds in the past to predict that Driver A will accelerate from 10 mph to 20 mph over 0.5 seconds in the future. A controller can apply that prediction to a cooling system to modulate the rate of cooling according to cool the vehicle more efficiently. A controller can apply a method to acquire that prediction then apply it to an adaptive cruise control system to emulate the acceleration patterns of the user. A controller can employ a method to calculate a distance-to-empty, acquire that prediction, then modulate the distance-to-empty according to the prediction.

The vehicle may include a system and a controller. The controller may be configured to change an output of the system according to a stored predicted rate of change in vehicle speed such that the greater the stored predicted rate, the greater the change. For example, consider Driver A and Driver C as above. If the system is a battery thermal management system, then the vehicle may be configured to use a predicted rate of change in vehicle speed from an initial speed to a final speed for Driver A, derived from data for Driver A previously transitioning from the initial speed to the final speed, to change the battery thermal management system to a greater degree (e.g., greater flow rate, increased power, etc.) compared to Driver C for the same initial speed to final speed change, as Driver A has a greater predicted rate of change in speed when transitioning from the initial speed to the final speed as compared to Driver C. Other systems are contemplated that may include an inverse relationship between the predicted rate of change and the change of a system.

To generate a personalized cruise control experience, the vehicle may use a predicted rate of change in speed for a user to change a control operation of a cruise control system. A cruise control system may autonomously maintain an approximately constant speed, including while travelling over inclined or declined terrain. Fluctuations in a speed of the vehicle occur responsive to a changed environmental condition. For example, if a cruise control system is maintaining a vehicle speed of 35 mph over level ground, and the vehicle starts to climb a hill, the vehicle speed may fluctuate to 30 mph. An adaptive cruise control system includes a feedback system wherein a fluctuation including a decreased speed generates an increased motor input and wherein a fluctuation including an increased speed generates a decreased motor input or activation of another vehicle system. In the prior example, after recognizing the vehicle's speed has fluctuated to 30 mph, the cruise control system may increase motor input to bring the vehicle back to 35 mph while climbing the hill.

The vehicle may use a predicted rate of change for a present driver to cause personalized corrective measures when changing energy to a motor responsive to a changed environmental condition to maintain a constant speed. For example, consider Driver A and Driver C as above. A cruise control system for Driver A may cause more energy to be delivered to a motor responsive to a changed environmental condition to cause the vehicle to return to the constant speed in less time than it would for Driver C in an otherwise equivalent situation.

A cruise control system may cause deceleration when a distance between the vehicle and a second vehicle in front of the vehicle decreases. The vehicle may use a predicted rate of change for a present driver to cause a personalized deceleration. For example, consider Driver A and Driver C as above. A cruise control system personalized for Driver A may cause deceleration of greater magnitude than a cruise control system personalized for Driver C in an otherwise equivalent situation.

A cruise control system may cause acceleration from an initial speed to a final speed. The vehicle may use a predicted rate of change for a present driver to cause personalized acceleration. For example, consider Driver A and Driver C as above. A cruise control system personalized for Driver A may cause acceleration of greater magnitude than a cruise control system personalized for Driver C in an otherwise equivalent situation.

A cruise control system may use additional information such as route information including directions, speed limits along the route, traffic along the route. weather; ambient temperature, or battery distance-to-empty to modulate a control operation of the cruise control system. For example, consider Driver A as above. A cruise control system personalized for Driver A may cause deceleration of greater magnitude on a clear, sunny day than on a freezing, snowy day in an otherwise equivalent situation. Modulation factors could be defined for any predetermined criteria in an additional information category.

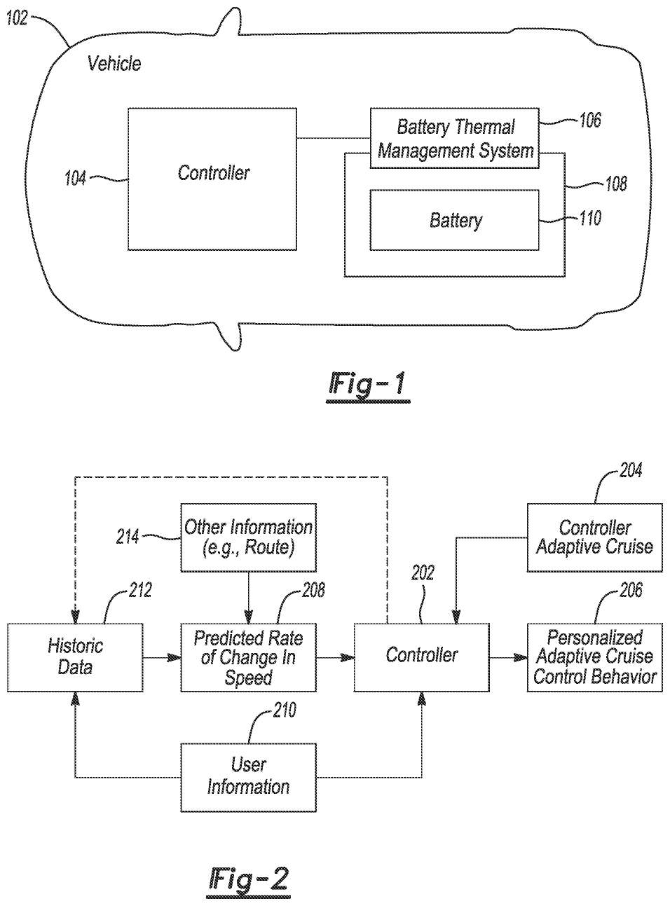

FIG. 1 shows a vehicle including a controller that modulates a battery thermal management system according to the particular user driving the vehicle. FIG. 1 includes a vehicle 102. The vehicle 102 includes a controller 104, a battery thermal management system 106, and a battery 110. The controller 104 is connected to the battery thermal management system 106. Generally, battery thermal management systems modulate a temperature of a battery. Here, the battery thermal management system 106 includes at least one cooling apparatus or method 108 to modulate a temperature of the battery 110. Generally, a cooling apparatus or method may or may not envelop a battery. Here, an enveloping depiction is used for teaching purposes and is not intended to be limiting.

The controller 104 may modulate the battery thermal management system 106 according to a particular user and according to a predicted rate of change in speed of the vehicle 102. For example, consider Driver A and Driver C as above. If Driver A operates the vehicle 102, the controller 104 may direct the battery thermal management system 106 to increase a cooling effect of the cooling apparatus or method 108 to keep the battery 110 within a predefined operating temperature. Alternatively, if Driver C operates the vehicle 102, the controller 104 may direct the battery thermal management system 106 to maintain the cooling effect of the cooling apparatus or method 108. By differentiating between Driver A's and Driver C's driving styles, the vehicle 102 thus more efficiently allocates resources to the battery thermal management system 106.

In one embodiment, the vehicle may determine a modulation parameter as soon as a user enters the vehicle and inputs route information. By applying the user's past behavior to a speed profile expected of the route information, the controller 104 may modulate the battery thermal management system 106 preemptively instead of reactively.

FIG. 2 shows a method employed by a controller for generating a personalized adaptive cruise control behavior. FIG. 2 includes a controller 202 that incorporates a user information 210 and a predicted rate of change in speed 208 to modulate an adaptive cruise control 204. The controller 202 modulates the adaptive cruise control 204 to generate a personalized adaptive cruise control behavior 206. The predicted rate of change in speed 208 is calculated from at least a historic data 212 associated with the user information 210.

In one embodiment, other information 214 is also used to calculate the predicted rate of change in speed 208. Other information 214 may include information related to a proposed route input, information about weather, information about temperature, or information about traffic. Those examples of other information 214 may be combined or included with other examples known to one of ordinary skill in the art to calculate the predicted rate of change in speed 208. For example, if the other information includes the weather is currently raining, the predicted rate of change in speed 208 may be reduced.

The controller 202 is defined here as any embodiment capable of employing the method claimed by using the user information 210 and the predicted rate of change in speed 208 to modulate an adaptive cruise control 204. In one embodiment, the controller 202 and the adaptive cruise control 204 may be part of a same system. In another embodiment, the following are all part of a single controller: the user information 210, the historic data 212, the other information 214, the predicted rate of change in speed 208, the controller 202, the adaptive cruise control 204, and the personalized adaptive cruise control behavior 206 generated. In other embodiments, the controller 202 may be replaced by an electrical component, by other components, by multiple components, by a different system, or by a sub-system including the adaptive cruise control 204.

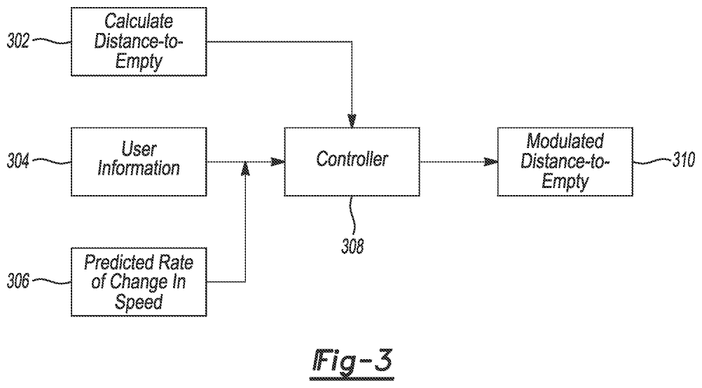

FIG. 3 shows a method employed by a controller to affect the accuracy of a distance-to-empty prediction. FIG. 3 shows a controller 308 defined as any embodiment capable of employing the method claimed. The controller 308 calculates a distance-to-empty 302 by a method such as comparing a charge percentage to an estimated distance-to-empty stored in a lookup table, a user information 304, and a predicted rate of change in speed 306 then outputs a modulated distance-to-empty 310.

For example, consider Driver A and Driver C as above. Because the user information and predicted rate of change in speed for Driver A suggests that Driver A will deplete a battery more quickly than an average driver would, the method may generate the modulated distance-to-empty 310 which, for Driver A, may be less than the calculated distance-to-empty 302. For Driver C, however, the method may generate the modulated distance-to-empty 310 which is greater than or equal to the calculated distance-to-empty 302 because the user information and predicted rate of change in speed for Driver C suggest that Driver C will deplete a battery at a rate less than or equal to an average driver.

In one embodiment, the controller 308 calculates the calculated distance-to-empty 302. In one embodiment, one of the user information or predicted rate of change in speed is stored separately from the controller 308.

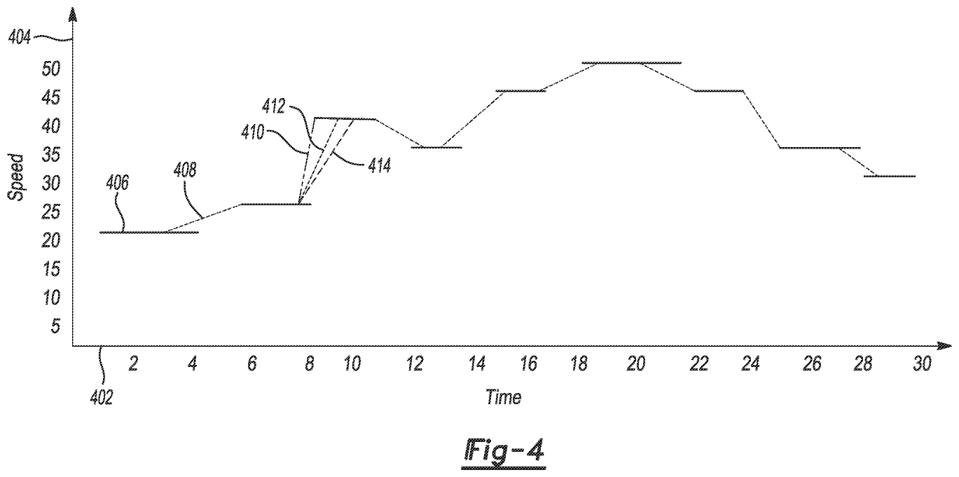

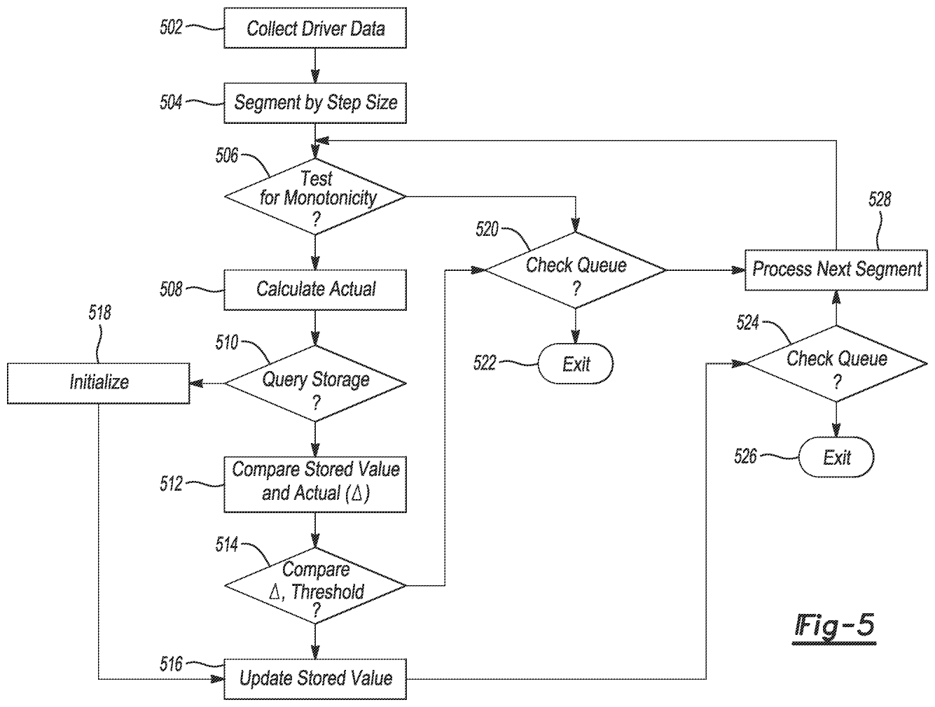

FIG. 4 shows an example speed vs. time graph generated for a user based on a route information. FIG. 4 shows an example relationship between a time 402 during which a vehicle has been driven and a speed 404 dependent on the time 402. At various times, this graph shows horizontal, solid lines that represent an expected constant speed, such as a first constant speed 406. At other times, this graph shows sloped, dashed lines that represent expected changes in speed, such as a first expected change in speed 408 and a second expected change in speed 412. Also depicted near the second expected rate of change in speed 412 are two expected changes in speeds 410, 414.

For example, consider Driver A and Driver C as above. A vehicle may generate a default graph of expected constant speeds and expected changes in speed. Then, the vehicle may use information derived from historic information, and in some examples generated via a machine learning model, to adjust the expected changes in speed to produce a Driver-A-specific expected change in speed 410 that is different than a Driver-C-specific change in speed 414. This example only discusses adjusting the second expected change in speed for teaching brevity and is not intended to be limiting. By incorporating a past driving behavior of a specific driver when generating a route information as depicted in FIG. 4, a vehicle may adjust all expected changes in speeds or any subset of expected changes in speeds to better predict time 402 and the resources expected to be used by the vehicle.

FIG. 5 shows a flowchart to an example method to update predicted rates of change in speed for a particular user. FIG. 5 includes a first step 502 of collecting driving data to acquire an actual rate of change in speed from the current user's behavior. A second step 504 includes segmenting the actual rate of change in speed based on a predefined step size, such as 5 mph. For example, using a 5-mph step size, if the actual rate of change in speed is collected over a driver changing from 55 mph to 75 mph, then the actual rate of change will be divided into four, 5-mph segments: 55 mph to 60 mph, 60 mph to 65 mph, 65 mph to 70 mph, and 70 mph to 75 mph.

In one embodiment, each segment generated by the second step 504 continues through a third step 506 and the rest of the flowchart individually. For teaching purposes, the following examples will discuss the 55 mph to 60 mph segment (“the 55-60 segment”) generated by the second step 504 above. The third step 506 includes testing whether a speed within a segment is monotonically increasing or decreasing. If the third step 506 results that the speed within the segment was monotonically increasing or decreasing, then the process moves to a fourth step 508. If the third step 506 results that the speed within the segment was not monotonically increasing or decreasing, then the process moves to a first administrative step 520.

In the fourth step 508, the actual time between an initial speed to a final speed is calculated. A fifth step 510 can occur before or simultaneously to the fourth step 508 and may occur in a different location than the fourth step 508. The fifth step 510 includes querying whether the vehicle has a stored value assigned to the segment generated by the second step 504. A stored value could be held in a first storage either online or offline. For example, the fifth step 510 for the 55-60 segment could include querying a data storage device to determine whether the vehicle already has data stored for the vehicle to move from 55 to 60 mph.

If the fifth step 510 results that the vehicle does not have a stored value assigned to the segment generated by the second step 504, then the process moves to an initial assignment step 518 wherein the actual time generated by the fourth step 508 becomes the stored value. For example, if the fifth step 510 returns no stored value for historic rates of change in speed from 55 to 60 mph specific to the particular driver, then the data recorded for the 55-60 segment will be assigned to that stored value. Some intermediate calculations or manipulations, including application of a machine learning algorithm, may be included before assignment. If the fifth step 510 results that the vehicle does have a value stored for the segment generated by the second step 504, then the process moves to a sixth step 512.

In the sixth step 512, a difference between the stored value and the actual rate of change in speed generated by the fourth step 508, called a “delta,” is calculated. In a seventh step 514, the delta is compared to a predetermined threshold error. If the delta is smaller than the predetermined threshold error, the process moves to the first administrative step 520. Otherwise, the process moves to an eighth step 516.

In the eighth step 516, the actual time generated by the fourth step 504 is used to update the stored value. This updating may include calculations involving assigning weights to the stored value and the actual time. This updating may include assigning the actual time to a training or testing dataset used to create or update a machine learning model. This updating may include application of a machine learning model. Following the eighth step 516, the process moves to a second administrative step 524.

The first administrative step 520 includes testing whether all the data from the first step 502 has been processed completely. If all the data has been processed, the process reaches a first termination 522 wherein updating activity ceases. If data remains to be processed, the process moves to a next iteration 528. The next iteration 528 processes a remaining segment. For example, if the 55-60 segment finished processing, the next iteration 528 may begin the third step 506 with one of the 60 mph to 65 mph segment, the 65 mph to 70 mph segment, or the 70 mph to 75 mph segment.

The second administrative step 524 includes testing whether all the data from the first step 502 has been processed completely. If all the data has been processed, the process reaches a second termination 526 wherein the vehicle may update a second storage then cease updating activity. In one embodiment, the first storage is an offline storage and the second storage is an online storage. If not all the data has been processed, the process moves to the next iteration 528.

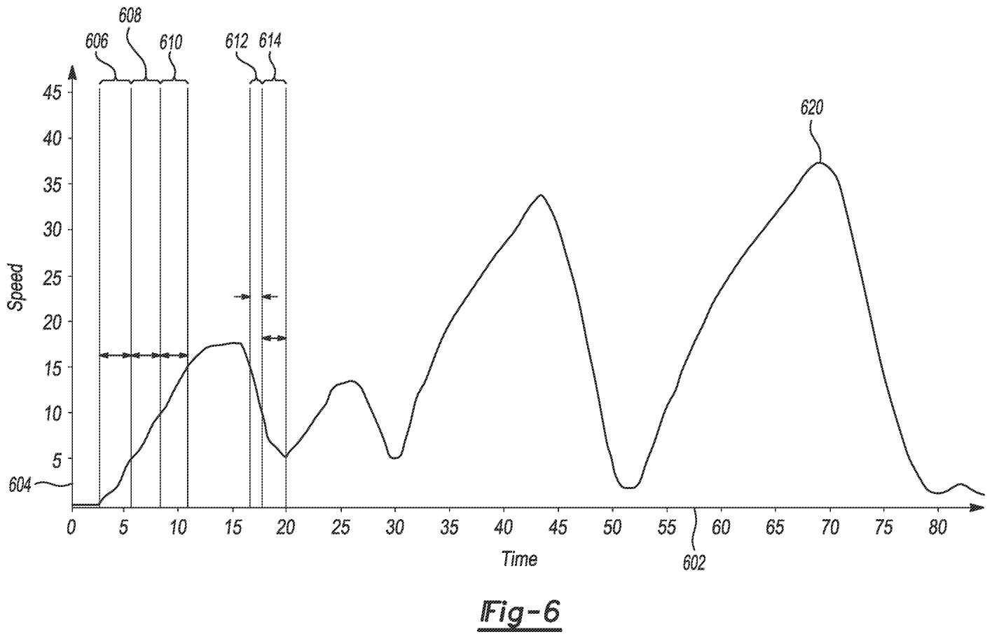

FIG. 6 shows an example speed vs. time graph of data taken during a particular user's drive. FIG. 6 shows an example relationship between a time 602 during which a vehicle has been driven and a speed 604 dependent on the time 602. Whereas the graph of FIG. 4 shows predicted speeds and predicted changes in speed, the graph of FIG. 6 shows an example of actual speeds collected during a drive.

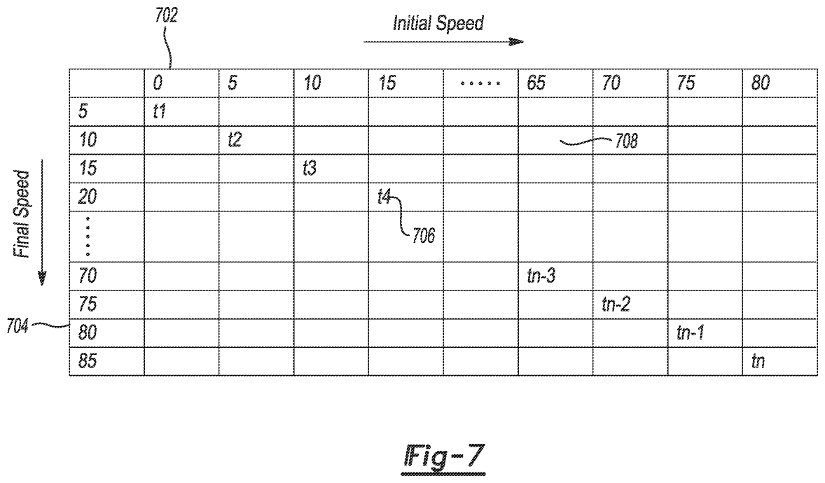

FIG. 7 shows an exemplary table for storing a particular user's predicted rates of change in speed. FIG. 7 shows stored values relating to the predicted rate of change in speed between an initial speed 702 and a final speed 704. In one embodiment, a stored value is a time taken to move from the initial speed to the final speed. For example, t4 706 is a stored value in a cell at the intersection of initial speed=15 mph and final speed=20 mph.

Applying the updating process of FIG. 5 to the graph of FIG. 6 and the table of FIG. 7 begins by the graph of FIG. 6 being input to the first step 502. In the second step 504, the data is segmented into 5-mph segments entitled t1 606, t2 608, t3 610, t3′ 612, t2′ 614. Only these segments are discussed for teaching brevity, but all potential segments or any subset of potential segments may be assessed. Segment t1 606 corresponds to a monotonic acceleration from 0 to 5 mph. Segment t2 608 corresponds to a monotonic acceleration from 5 to 10 mph. Segment t3 610 corresponds to a monotonic acceleration from 10 to 15 mph. Segment t3′ 612 corresponds to a monotonic deceleration from 15 to 10 mph. Segment t2′ 614 corresponds to a monotonic deceleration from 10 to 5 mph.

Because all segments are monotonically increasing or monotonically decreasing, all segments will pass the third step 506 although only one segment will be tested at a time in some embodiments.

In an embodiment wherein stored values are kept in a tabular format, t1 606, t2 608, t3 610, t3′ 612, and t2′ 614 will update or initialize a cell at the intersection of the initial speed axis 702 and the final speed axis 704 corresponding to the initial speed and the final speed of the segment, respectively. For example, t1 606 would update or initialize the cell at the intersection of initial speed=0 mph and final speed=5 mph. Similarly, t3′ 612 would update or initialize the cell at the intersection of the initial speed=15 mph and final speed=10 mph.

Note the 65-20 cell 708 at the intersection of initial speed=65 mph and final speed=20 mph. An example process using a fixed 5 mph step size does not allow the 65-20 cell 708 to carry a value because data of a deceleration from 65 to 20 mph would be split into 5-mph segments. A different embodiment may allow the 65-20 cell 708 to carry a value.

The scaling of the table of FIG. 7 suggests that the table depicted only stored values relating to an increasing speed. In such an embodiment, values relating to a decreasing speed would be stored elsewhere. In other embodiments, however, data relating to both increasing speeds and decreasing speeds are captured in the same table. In yet other embodiments, data relating to both increasing speeds and decreasing speeds may be contained within a different data structure.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a battery thermal management system; and
a controller programmed to, for a particular user and responsive to a predicted rate of change in speed of the vehicle from a current speed to a target speed derived from data indicative of the particular user driving the vehicle while the speed changed from the current speed to the target speed, change a rate of cooling of the battery thermal management system according to the predicted rate such that a greater the predicted rate, a greater the change.

2. The vehicle of claim 1, wherein the controller is further programmed to, responsive to a difference between the predicted rate and a present rate of change being greater than a predetermined threshold, update the predicted rate according to the present rate.

3. The vehicle of claim 2, wherein the controller is further programmed to use machine learning algorithms to perform the updating.

4. The vehicle of claim 1, wherein the controller is further programmed to, responsive to a difference between the predicted rate and a present rate of change being greater than a predetermined threshold and the present rate being defined by monotonically increasing or monotonically decreasing values, update the predicted rate according to the present rate.

5. The vehicle of claim 4, wherein the controller is further programmed to, responsive to the present rate being defined by non-monotonically increasing or non-monotonically decreasing values, preclude the updating regardless of the difference.

6. The vehicle of claim 1, wherein the controller is further programmed to change the rate of cooling further responsive to, at least one of weather, driving condition, ambient temperature, or a predicted route.

7. A method for generating personalized adaptive cruise control commands, comprising:
acquiring (i) data about a user including historic drive data generated by one or more vehicles driven by the user and (ii) a predicted rate of change in vehicle speed generated by a machine learning model that uses the historic drive data as input; and
applying the data and the predicted rate to an adaptive cruise control system of a vehicle to modulate a control operation of the adaptive cruise control system.

8. The method of claim 7 further comprising updating the historic drive data when the user generates an actual rate of change in speed by changing from an initial speed to a final speed.

9. The method of claim 8, wherein the updating is responsive to a difference between the actual rate of change in speed and the predicted rate of change in speed exceeding a threshold value.

10. The method of claim 8 further comprising precluding the updating when the vehicle moves from the initial speed to the final speed non-monotonically.

11. The method of claim 7, wherein the applying further includes at least one of route information, weather, ambient temperature, or battery distance-to-empty.

12. The method of claim 7, wherein the control operation of the adaptive cruise control system includes decelerating responsive to a distance to a leading vehicle decreasing.

13. The method of claim 7, wherein the control operation of the adaptive cruise control system includes accelerating from an initial speed to a final speed.

14. The method of claim 7, wherein the control operation of the adaptive cruise control system includes autonomously maintaining a constant speed.

15. The method of claim 7, wherein the control operation of the adaptive cruise control system includes maintaining a constant speed while travelling over inclined or declined terrain.

16. A method to predict a distance-to-empty, comprising:
acquiring (i) data about a user including historic drive data generated by one or more vehicles driven by the user and (ii) a predicted rate of change in vehicle speed generated by a machine learning model that uses the historic drive data as input; and
changing a distance-to-empty value according to the data and the predicted rate such that the greater the predicted rate, the greater the changing.

17. The method of claim 16 further comprising updating the predicted rate when a difference between the predicted rate and an actual rate of change collected when a speed changes monotonically between an initial speed and a final speed exceeds a predetermined value.

18. The method of claim 17, wherein the updating changes the historic drive data for the user.

19. The method of claim 17, wherein the updating further utilizes a machine learning algorithm to change the predicted rate of change to an updated predicted rate of change.

20. The method of claim 17, wherein the predetermine value is at least 5 mph.
